(19) United States
(12) Patent Application Publication
(10) Pub. No.: US 2016/0306566 A1
(43) Pub. Date: Oct. 20, 2016

(54) DATA REORDER DURING MEMORY ACCESS

(71) Applicants: Shih-Lien L. Lu, Portland, OR (US); Chun Shiah, Hsinchu (TW); Bordoou Rong, Chupei (TW); Andre Schaefer, Sassenburg (DE)

(72) Inventors: Shih-Lien L. Lu, Portland, OR (US); Chun Shiah, Hsinchu (TW); Bordoou Rong, Chupei (TW); Andre Schaefer, Sassenburg (DE)

(21) Appl. No.: 15/038,031

(22) PCT Filed: Dec. 26, 2013
(86) PCT No.: PCT/US2013/077878

§ 371 Date: May 19, 2016

(51) Int. Cl. G06F 3/06; G06F 9/30

(52) U.S. Cl. CPC G06F 3/0613; G06F 3/0659; G06F 3/0673; G06F 9/30101

(57) ABSTRACT

Embodiments including systems, methods, and apparatuses associated with reordering data retrieved from a dynamic random access memory (DRAM). A memory controller may be configured to receive an instruction from a central processing unit (CPU) and, based on the instruction, retrieve a sequential data from a DRAM. The memory controller may then be configured to reorder the sequential data and place the reordered data in one or more locations of a vector register file.

### FIELD

Embodiments of the present invention relate generally to the technical field of memory access.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Many applications, and particularly high performance computing applications such as graphics that may require intensive calculations, may work with vectors. For example, data may be loaded into a vector register file and then processed by multiple vector processing units working in parallel with one another. Specifically, the data may be divided between a plurality of vector registers of a vector register file, and then a vector processing unit may process the data in a given vector register.

In embodiments, the process of retrieving the data from a plurality of memory addresses and writing the data into a vector register may be referred to as a “gather” operation. By contrast, the process of writing the data from a vector register into a plurality of memory address locations may be referred to as a “scatter” operation.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example system including a memory controller, in accordance with various embodiments.

FIG. 2 illustrates an example table of memory reordering operations, in accordance with various embodiments.

FIG. 3 illustrates an alternative example table of memory reordering operations, in accordance with various embodiments.

FIG. 4 illustrates an example process for reordering data read from a memory, in accordance with various embodiments.

FIG. 5 illustrates an example system configured to perform the processes described herein, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Apparatuses, methods, and storage media associated with processing of sequential data are described herein. Specifically, in legacy systems a vector register file may include a plurality of vector registers, and a plurality of vector processing uniting units may be configured to process the data of each of the respective vector registers. For example, the sequential data may be divided into a series of “chunks” of the data, and each chunk may be processed by a different vector processing unit.

In some embodiments, it may be desirable for a specific vector processing unit to process a specific chunk of data rather than another chunk of data. In existing legacy systems, the sequential data may be read from a memory, and each chunk of the sequential data may be placed into a vector register of a vector register file. Next, the order of the data in the various vector registers may be shuffled so that the desired chunk of data is in a desired vector register of a vector register file. Finally, the data may be processed by the various vector processing units. However, embodiments herein provide a process which may increase the efficiency of loading data into a vector processing unit and processing the data. Specifically, in embodiments described herein a central processing unit (CPU) may send a command to a memory controller that is coupled with a memory such as a dynamic random access memory (DRAM) where the data is stored. Based on the command, the memory controller may retrieve the data from the DRAM and reorder the data before the data is loaded into the one or more vector registers of the vector register file. Then, the memory controller may load the reordered data into the one or more vector registers of the vector register file according to the reordering. Various benefits may be realized by reordering the data during the retrieval process, rather than after the data is loaded into the vector register file. For example, the number of signals that are required to be transmitted from the CPU may be reduced. Additionally, the loading and processing time, and therefore the latency of the system, may be reduced. Additional or alternative benefits may also be realized.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, laptop computer, a set-top box, a gaming console, and so forth.

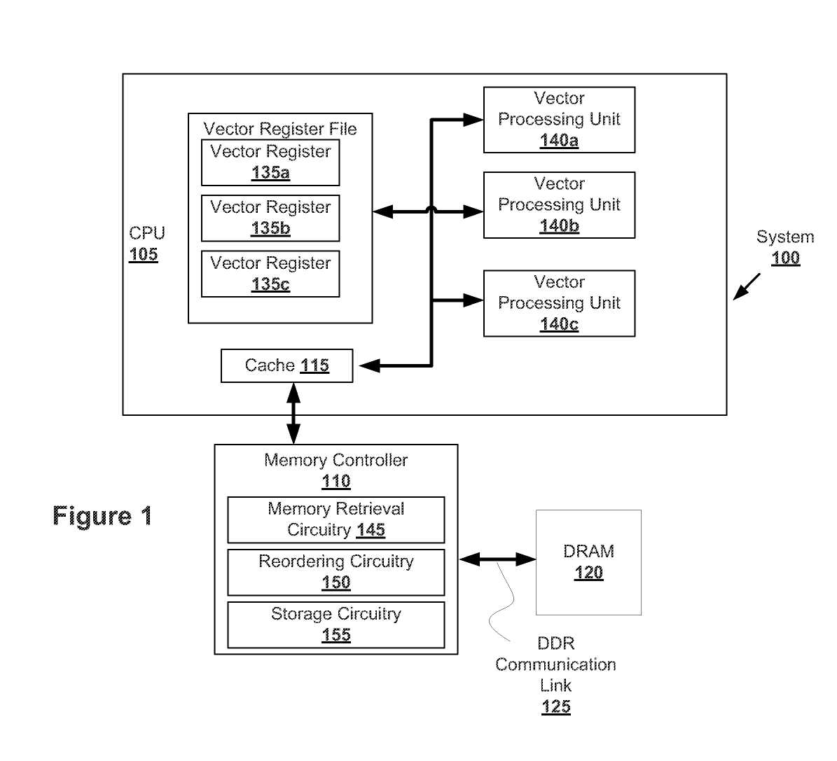

FIG. 1 depicts an example of a system 100 which may allow for more efficient gather of data into a vector register file. In embodiments, a CPU 105, and specifically elements of the CPU 105 such as a vector register file 130 discussed below, may be coupled with a memory controller 110 via one or more buses. In embodiments, the memory controller 110 may additionally be coupled with a DRAM 120. In embodiments described herein, the DRAM 120 may be a synchronous DRAM (SDRAM), a double data rate (DDR) DRAM such as a second generation (DDR2), third generation (DDR3), or fourth generation (DDR4) DRAM, or some other type of DRAM. In some embodiments, the memory controller 110 may be coupled with the DRAM 120 via a DDR communication link 125.

In embodiments the memory controller 110 may additionally be coupled with a vector register file 130 of the CPU 105, which may comprise a plurality of vector registers 135a, 135b, and 135c. In some embodiments, the vector register file 130 may be called a single instruction multiple data (SIMD) register file. Each of the vector registers may be configured to store a portion of a data that is retrieved by the memory controller 110 from the DRAM 120. In embodiments, the vector register file 130 may be coupled with a plurality of vector processing units 140a, 140b, and 140c of the CPU 105. The vector processing units 140a, 140b, and 140c may be configured to process a portion of the data in one or more of the vector registers 135a, 135b, or 135c of the vector register file 130 in parallel with another of the vector processing units 140a, 140b, or 140c processing another portion of the data in a different one or more vector registers 135a, 135b, or 135c of the vector register file 130. For example, vector processing unit 140a may process the data of vector register 135a in parallel with vector processing unit 140b processing the data of vector register 135b. Although FIG. 1 only depicts the vector register file 130 as having three vector registers 135a, 135b, and 135c, in other embodiments the vector register file 130 may have more or fewer vector registers. Additionally, the system 100 may include more or less vector processing units than the three vector processing units 140a, 140b, and 140c depicted in FIG. 1.

Although certain elements are shown as elements of one another or coupled with one another, in other embodiments one or more of the elements may be on the same chip or package in a system on chip (SoC) or system in package (SiP) configuration, or may be separate from one another. For example, one or more of the vector register file 130 and/or vector processing units 140a, 140b, and 140c may be separate from the CPU 105. Alternatively, a single chip may include one or more of the CPU 105, the memory controller 110, the vector register file 130 and vector processing units 140a, 140b, or 140c.

In some embodiments, the memory controller 110 may contain one or more modules or circuits such as memory retrieval circuitry 145, reordering circuitry 150, and storage circuitry 155. In embodiments, the memory retrieval circuitry 145 may be configured to retrieve one or more portions of data from the DRAM 120. The reordering circuitry 150, as will be discussed in further detail below, may be configured to reorder the data retrieved by the memory retrieval circuitry 145. Storage circuitry 155 may be configured to place the reordered data into the vector register file 130.

In embodiments, the CPU 105 may be configured to transmit an instruction to memory controller 110. The instruction, which may be an SIMD instruction, may include, for example, an instruction for the memory controller 110 to generate an “ACTIVE” command. In some embodiments, the instruction may be or include a “LOAD” or “MOV” instruction from the CPU 105 which may include an indication of a location of a desired data in the DRAM 120. The ACTIVE command may cause the memory controller 110 to activate (open) a memory location, or “page,” in the DRAM 120 where data may be stored or retrieved. In some embodiments the location opened by the ACTIVE command may include multiple thousands of bytes of data. If subsequent access to the memory is within the range of the page opened, only a subset of the addresses may need to be supplied to select data within the page. In embodiments, the ACTIVE command may also identify a row address of the DRAM 120 where the data is stored.

After the ACTIVE command, the memory controller 110 may generate a “READ” or “WRITE” command In some embodiments, the READ or WRITE command may be generated in response to the same instruction that generated the ACTIVE command, and in other embodiments the READ or WRITE command may be generated in response to a separate instruction from the CPU 105. In some embodiments, one or all of the ACTIVE, READ, or WRITE commands may include a memory address of the DRAM 120 such as a column address or row address of a location in the DRAM 120. Specifically, the instruction from the CPU 105 may include one or more memory addresses which may be translated to specific row and column addresses in the DRAM 120. This translation may be done by the memory controller 110 and may be proprietary to achieve other purposes such as to distribute accesses to the DRAM 120 evenly. Because the DRAM 120 may be organized as a 2D array, the row address in the ACTIVE, READ, or WRITE commands may select the row of the DRAM 120 where the desired data is stored, and the column address of the ACTIVE, READ, or WRITE commands may select the column of the DRAM 120 being accessed. In some embodiments, the row and column addresses may be latched in some DRAMs.

The CPU 105 may transmit the instruction to the memory controller 110 after a number of clock cycles. Alternatively, the CPU 105 may transmit the instruction to the memory controller 110, and the memory controller 110 may implement the instruction after a number of clock cycles. For example, in some embodiments the memory controller 110 may be able to track the number of clock cycles between certain commands according to one or more preset parameters of the memory controller 110. In embodiments, the number may be measured in t_{RCD} cycles, which may correspond to the time between the memory controller 110 issuing a row address strobe (RAS) to the memory controller 110 issuing a column address strobe (CAS).

In some embodiments, the instruction from the CPU may cause the memory controller 110, through the READ command to read the data into one or more of the vector registers 135a, 135b, or 135c. This read of the data may be accomplished by asserting the pins of the DRAM 120 corresponding to a portion of the command such as the column address or the row address of the memory location of the DRAM 120 where the data is stored. One or more pins of the DRAM 120 may correspond to the column address of the READ command. Through the assertion of these pins, data may be delivered from the DRAM 120 to the memory controller 110 in a “burst,” as described in greater detail below.

Specifically, the DRAM 120 may have a plurality of pins through which it can transmit or receive specific signals from the memory controller 110. Commands received on a specific pin may cause the DRAM 120 to perform a specific function, for example reading data as described above, or writing data as described below.

By contrast, the WRITE command may cause the memory controller 110 to write data from the vector registers 135a, 135b, and 135c to the memory location of the DRAM 120 specified by the WRITE command.

In some embodiments the data stored in the DRAM 120 may be sequential data. As an example of sequential data, the data may be 64 bytes long and organized in eight 8 byte chunks. The first 8 byte chunk of the 64 bytes may be referred to as the 0^{th} chunk, the second 8 byte chunk of the 64 bytes may be referred to as the 1^{st} chunk, and so on. In total, the sequential data may be made up of chunks 0, 1, 2, 3, 4, 5, 6, and 7.

In some embodiments, CPU 105 may include a cache 115. As shown in FIG. 1, in some embodiments the cache 115 may be coupled with and between the memory controller 110 and/or the vector register file 130. In some embodiments the cache 115 may also be coupled with one or more of vector processing units 140a, 140b, and 140c. In some embodiments, one or more of the vector processing units 140a, 140b, and 140c and/or vector register file 130 may be configured to access data from the cache 115 before attempting to access data from the DRAM 120 by way of memory controller 110.

Specifically, many modern microprocessors such as CPU 105, may employ caches to reduce the average latency of the system. The cache 115 may include one or more layers such as an L1 layer, an L2 layer, an L3 layer, etc. In embodiments, access to data in the DRAM 120 of the system 100 may be based on the size of the cache line of the memory controller 110. For example, in some embodiments the cache line size may be 64 bytes. In this embodiment, transferring a 64 byte cache line from the DRAM 120 to the vector register file 130 may require eight consecutive 8 byte chunks of data.

In some legacy embodiments, not shown herein, where scalar registers and a scalar register file are used, as opposed to the vector register file 130 of the present embodiment, it may be desirable for a chunk that is not first in the sequential data, which may be herein referred to as a prioritized chunk, to be input to the scalar register file prior to the other chunks so that a processor, for example the CPU 105, associated with the scalar register can operate on the data immediately while the remainder of the sequential data is read from a DRAM such as DRAM 120. Providing a prioritized chunk to a scalar register may be desirable because a scalar register may only be able to process a single chunk of data at a time, as opposed to a vector register file such as vector register file 130 which may be coupled with one or more vector processing units 140a, 140b, and 140c that are configured to process chunks of the sequential data in parallel with one another. In some embodiments, the READ command may be configured to access the prioritized chunk from the DRAM 120 based at least in part on a starting column address of the READ command and whether the READ command includes an indication of whether the burst type is sequential or interleaved, as explained in further detail below.

In embodiments of the present disclosure, a similar READ command may be used to access sequential data from a DRAM 120. However, in embodiments of the present disclosure, the READ command may also be used to determine which chunk of data is placed in which vector register of a vector register file such as vector registers 135a, 135b, and 135c of vector register file 130. It may be desirable to place a particular chunk of the data in a particular vector register so that a given vector processing unit may process that chunk of data. For example, in some embodiments it may be desirable for vector processing unit 140a to process the second chunk of the sequential data while the vector processing unit 140b processes the fourth chunk of the sequential data. Processing of a chunk of the data by a given vector processing unit may be based on a requirement of a specific algorithm, process, or some other requirement.

Specifically, in some embodiments vector operators may be referred to as SIMD commands. In embodiments, populating the vector registers 135a, 135b, and 135c of vector register file 130 with specific chunks of data may be accomplished using one or more SIMD commands. Specifically, a SIMD instruction may be used to shuffle 32-bit or 64-bit vector elements of a sequential data, with a vector register file such as vector register file 130 or memory operand as a selector.

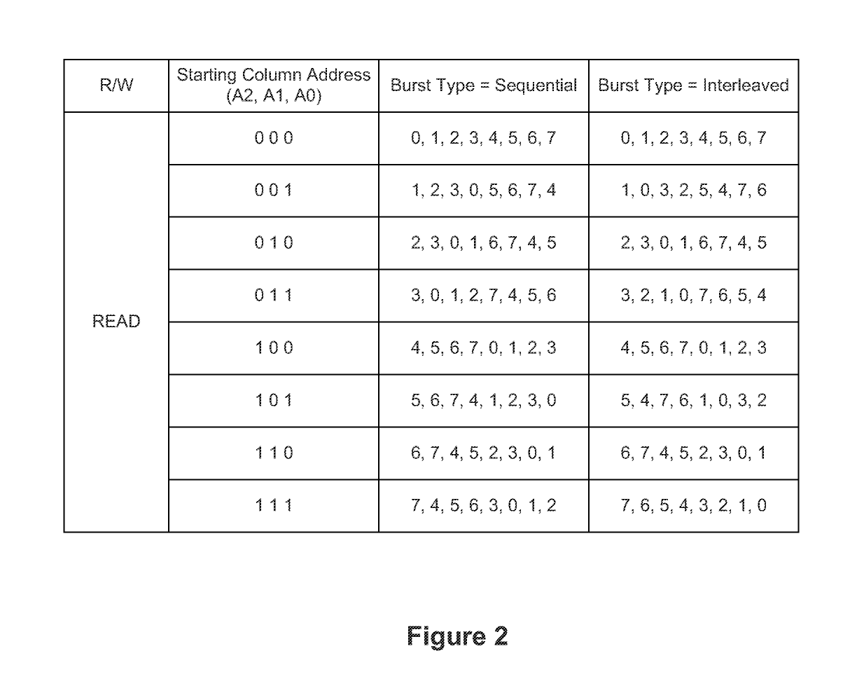

FIG. 2 depicts an example of a table that may be used to reorder the chunks of the sequential data in the vector register file. As noted above, the CPU 105 may transmit a READ command to a memory controller 110. The READ command may include a starting column address. Additionally or alternatively, the READ command may include an indication of whether the retrieval of the sequential data from the DRAM 120 is to be sequential or interleaved. In sequential burst mode, chunks of the sequential data may be accessed in increasing address order, wrapping back to the start of the block when the end is reached. By contrast, an interleaved burst mode may identify chunks using an Exclusive OR″ (XOR) operation based on a starting address and the counter value. In some embodiments, the interleaved burst mode may be simpler or more computationally efficient because the XOR operation may be simpler to implement on logic gates that the “add” operation which may be used for sequential burst mode.

As shown in FIG. 2, based on the starting column address and the indication of the burst type in the instruction received from the CPU 105, for example in the “LOAD” or “MOV” instructions discussed above, the memory controller 110 may access the sequential data, reorder the sequential data, and then store the reordered data in vector registers 135a, 135b, and 135c of vector register file 130. Specifically, the memory retrieval circuitry 145 of the memory controller 110 may access the sequential data stored in the DRAM 120. The access to the data may be based at least in part on an indication in the READ command of the column and/or row address of the data in the DRAM 120.

Next, the memory controller 110, and specifically the reordering circuitry 150 of the memory controller 110, may reorder the sequential data retrieved by the memory retrieval circuitry 145 from the DRAM 120. Specifically, the chunks of sequential data may be reordered according to the indication of the burst type and the starting column address of the READ command. As an example, assume that the sequential data is comprised of 64 bytes organized into eight sequential chunks of 8 bytes each and labeled as chunks 0, 1, 2, 3, 4, 5, 6, and 7. In this example, the READ command may have a starting column address of “1, 0, 0.” As indicated by FIG. 2, this starting column address may indicate that the sequential data should be reordered as chunks 4, 5, 6, 7, 0, 1, 2, and 3. In other words, the starting column address of “1, 0, 0” may indicate that the first 32 bytes of the sequential data and the second 32 bytes of the sequential data should be swapped. In this example, the indication in the READ command of whether the burst type is sequential or interleaved may not affect the reordering.

The storage circuitry 155 of the memory controller 110 may then store the reordered data in the vector registers 135a, 135b, and 135c of the vector register file according to the reordering indicated by the READ command. For example, continuing the example above, chunk 4 may be stored in vector register 135a for processing by vector processing unit 140a, chunk 5 may be stored in vector register 135b for processing by vector processing unit 140b, chunk 6 may be stored in vector register 135c for processing by vector processing unit 140c, and so on.

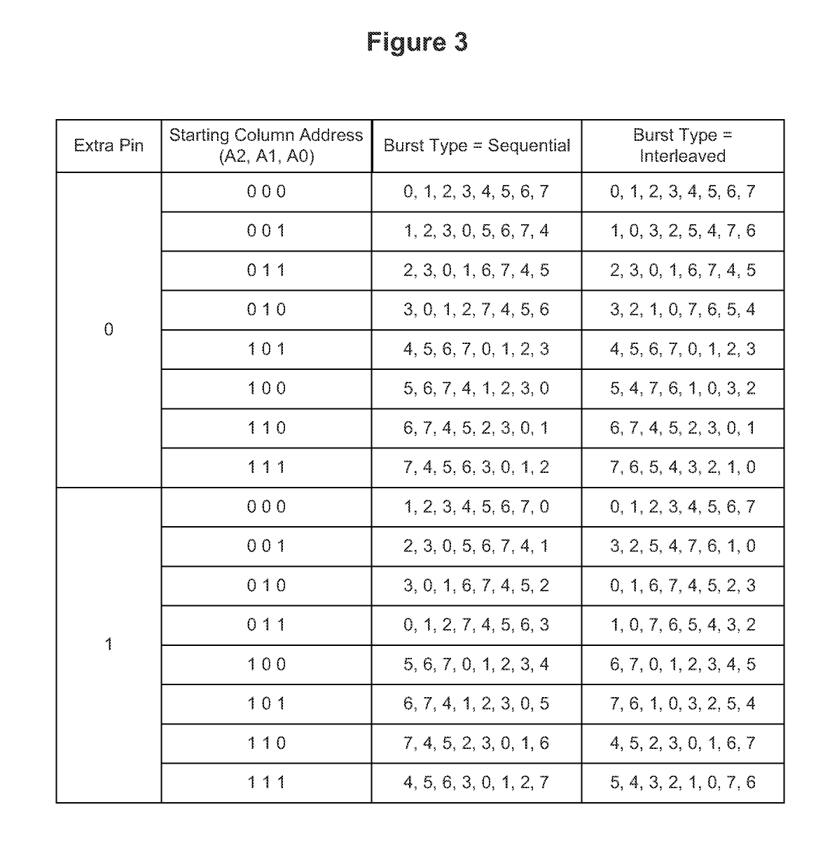

In other embodiments, one or more additional interfaces and/or logic may be added to include other data permutations beyond the sequences listed in FIG. 2. FIG. 3 depicts an example of a table that may indicate reordering of the data using an additional interface. Specifically, an extra pin may be added to the CPU 105 so that an extra bit of data may be transmitted to the memory controller 110 along with the READ command. As shown in the embodiment of FIG. 3, the extra pin may allow up to eight additional permutations of the reordered sequential data.

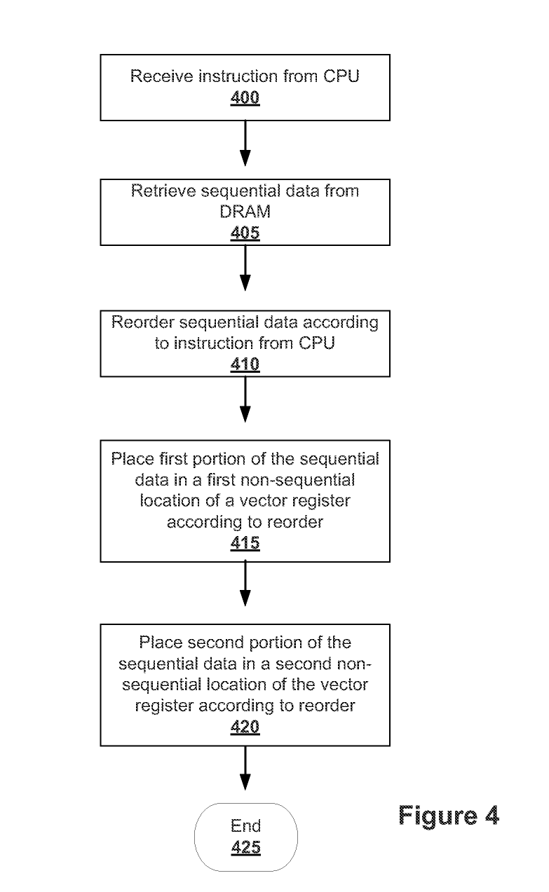

FIG. 4 depicts an example process that may be performed by the memory controller 110 as described above. Initially, the memory controller 110 may receive an instruction from a CPU such as CPU 105 at 400. The instruction may be, for example, the READ command discussed above.

Next, the memory controller 110 may retrieve the sequential data from a DRAM such as DRAM 120 at 405. Specifically, the memory retrieval circuitry 145 of the memory controller 110 may retrieve the sequential data from the DRAM 120.

After, retrieving the sequential data from the DRAM, the memory controller 110, and specifically the reordering circuitry 150 of the memory controller 110, may reorder the sequential data according to the instruction from the CPU 105 at 410. For example, the memory controller 110 may reorder the data according to one or more of a starting column address, an indication of a burst type, or an indication received on one or more additional interfaces or logic elements such as a pin from the CPU 105, as described above.

After reordering the data, the memory controller 110, and specifically the storage circuitry 155 of the memory controller 110, may place a first portion of the sequential data in a first non-sequential location of a vector register file according to the reorder at 415. Specifically, the memory controller 110 may place a chunk of the data in a vector register of a vector register file such as vector register 135a of vector register file 130. The chunk of data may be the first chunk of the sequential data. Next, the memory controller 110, and specifically the storage circuitry 155 of the memory controller 110, may place a second portion of the sequential data in a second non-sequential location of the vector register file according to the reorder at 420. For example, the memory controller 110 may place the second chunk of the sequential data in a vector register of the vector register file such as vector register 135c of vector register file 130. The process may then end at 425.

It will be understood that the above described chunks and vector registers are merely examples of the process that may be used by the memory controller to reorder sequential data retrieved from an DRAM such as DRAM 120 and stored the reordered data in vector registers of a vector register file such as vector registers 135a, 135b, and 135c of vector register file 130. The descriptions of “first and second” are used herein to distinguish between two different chunks of the sequential data, and should not be construed as limiting the description to only the first two chunks of the sequential data. Similarly, the descriptions of “first and second” as used herein with respect to the vector registers are intended to be descriptive, not limiting.

Although the examples above are given with respect to 64 bytes of data, the data reordering process may be further extended to a larger range. For example, although burst order is described as only including 8 chunks, in other embodiments a greater or less number of chunks may be used. Additionally each chunk may include more or fewer bytes of data. In some embodiments, DRAM such as DRAM 120 may include data on the order of thousands of bits, and the chunks and/or length of sequential data may be expanded to include an increased amount of data. One way of expanding the amount of data that could be reordered according to the processes described above may be to use additional column addresses in the READ command, or transmit additional data from the CPU to the memory controller using additional pins as described above in FIG. 3. In other embodiments, the data reordering process may be extended to a “stride” of data wherein instead of the sequential data including consecutive chunks {0,1,2,3,4,5,6,7}, the sequential data may include non-consecutive chunks {0,2,4,6,8,10,12,14} or some other sequential non-consecutive increment. In some embodiments, changing the amount of data send to the memory controller or the column address of the READ command may require additional logic in a DRAM to process the additional commands or data. Additionally, although the above described processes are described with respect to a vector register file 130, in some embodiments the process of retrieving the sequential data from the DRAM, reordering the data, and then supplying the data to the register may be used to supply data to a scalar register where a specific order of the chunks of data, beyond just the prioritized chunk of data, is desirable.

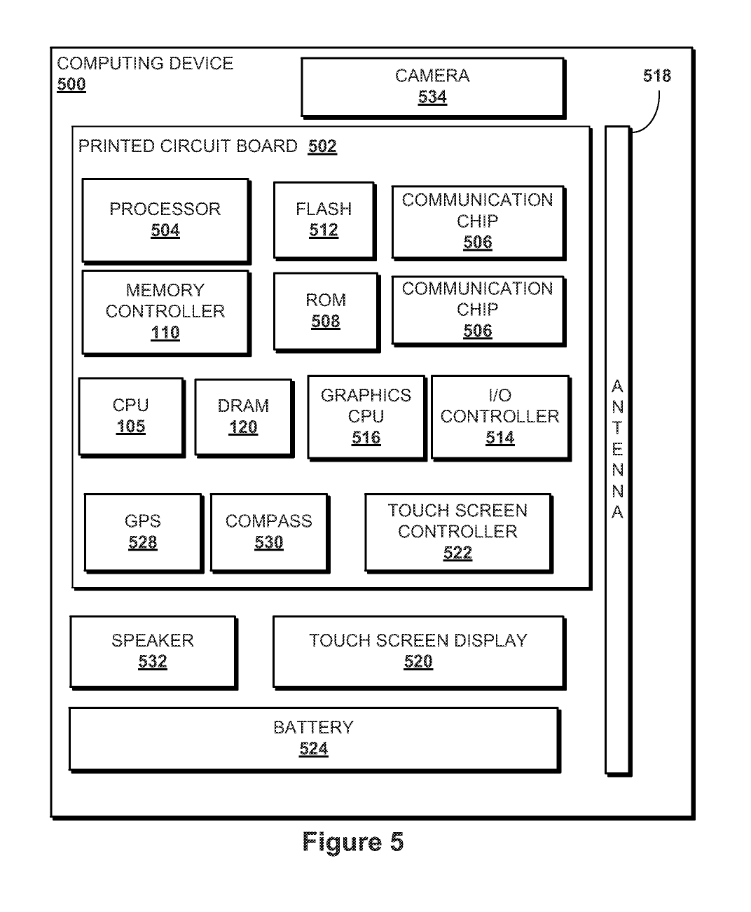

FIG. 5 illustrates an example computing device 500 in which systems such as the earlier described CPU 105, memory controller 110 and/or DRAM 120 may be incorporated, in accordance with various embodiments. Computing device 500 may include a number of components, one or more additional processor(s) 504, and at least one communication chip 506.

In various embodiments, the one or more processor(s) 504 or the CPU 105 each may include one or more processor cores. In various embodiments, the at least one communication chip 506 may be physically and electrically coupled to the one or more processor(s) 504 or CPU 105. In further implementations, the communication chip 506 may be part of the one or more processor(s) 504 or CPU 105. In various embodiments, computing device 500 may include printed circuit board (PCB) 502. For these embodiments, the one or more processor(s) 504, CPU 105, and communication chip 506 may be disposed thereon. In alternate embodiments, the various components may be coupled without the employment of PCB 502.

Depending on its applications, computing device 500 may include other components that may or may not be physically and electrically coupled to the PCB 502. These other components include, but are not limited to, volatile memory (e.g., the DRAM 120), non-volatile memory such as ROM 508, an I/O controller 514, a digital signal processor (not shown), a crypto processor (not shown), a graphics processor 516, one or more antenna 518, a display (not shown), a touch screen display 520, a touch screen controller 522, a battery 524, an audio codec (not shown), a video codec (not shown), a global positioning system (GPS) device 528, a compass 530, an accelerometer (not shown), a gyroscope (not shown), a speaker 532, a camera 534, and a mass storage device (such as hard disk drive, a solid state drive, compact disk (CD), digital versatile disk (DVD)) (not shown), and so forth. In various embodiments, the CPU 105 may be integrated on the same die with other components to form a System on Chip (SoC) as shown in FIG. 1. In embodiments, one or both of the DRAM 120 and/or the ROM 508 may be or may include a cross-point non-volatile memory.

In various embodiments, computing device 500 may include resident persistent or non-volatile memory, e.g., flash memory 512. In some embodiments, the one or more processor(s) 504, CPU 105, and/or flash memory 512 may include associated firmware (not shown) storing programming instructions configured to enable computing device 500, in response to execution of the programming instructions by one or more processor(s) 504, CPU 105, or the memory controller 110 to practice all or selected aspects of the blocks described above with respect to FIG. 4. In various embodiments, these aspects may additionally or alternatively be implemented using hardware separate from the one or more processor(s) 504, CPU 105, memory controller 110, or flash memory 512.

The communication chips 506 may enable wired and/or wireless communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Bluetooth, derivatives thereof, as well as any other wireless protocols that are designated as 3G, 4G, 5G, and beyond. The computing device 500 may include a plurality of communication chips 506. For instance, a first communication chip 506 may be dedicated to shorter range wireless communications such as Wi-Fi and Bluetooth and a second communication chip 506 may be dedicated to longer range wireless communications such as GPS, EDGE, GPRS, CDMA, WiMAX, LTE, Ev-DO, and others.

In various implementations, the computing device 500 may be a laptop, a netbook, a notebook, an ultrabook, a smartphone, a computing tablet, a personal digital assistant (PDA), an ultra mobile PC, a mobile phone, a desktop computer, a server, a printer, a scanner, a monitor, a set-top box, an entertainment control unit (e.g., a gaming console), a digital camera, a portable music player, or a digital video recorder. In further implementations, the computing device 500 may be any other electronic device that processes data.

In embodiments, a first example of the present disclosure may include a memory controller comprising: retrieval circuitry configured to retrieve data including a plurality of portions ordered in a first sequence based at least in part on an instruction from a central processing unit (CPU); reordering circuitry coupled with the retrieval circuitry and configured to reorder the data, based at least in part on the received instruction, so that the plurality of portions are ordered in a second sequence different from the first sequence; and storage circuitry configured to store, based at least in part on the received instruction, the plurality of portions in a respective plurality of locations of a vector register file in the second sequence.

Example 2 may include the memory controller of example 1, wherein the second sequence is based at least in part on a starting column address of the instruction.

Example 3 may include the memory controller of example 1, wherein the second sequence is based at least in part on an indication of a burst type in the instruction.

Example 4 may include the memory controller of example 3, wherein the indication of the burst type is an indication of whether the burst type is a sequential burst type or an interleaved burst type.

Example 5 may include the memory controller of example 1, wherein the second sequence is based at least in part on a pin setting of the CPU.

Example 6 may include the memory controller of any of examples 1-5, wherein the memory controller is coupled with a dynamic random access memory (DRAM) configured to store the data.

Example 7 may include the memory controller of any of examples 1-5, wherein the data is 64 bytes long.

Example 8 may include the memory controller of example 7, wherein each portion in the plurality of portions is 8 bytes long.

Example 9 may include a method comprising: retrieving, by a memory controller and based at least in part on an instruction received from a central processing unit (CPU), a first portion of a sequential data and a second portion of the sequential data, the first portion and the second portion being next to one another in the sequential data; placing, by the memory controller, the first portion in a first non-sequential location of a vector register file; and placing, by the memory controller, the second portion in a second non-sequential location of the vector register file.

Example 10 may include the method of example 9, wherein the memory controller is further configured to place the first portion in the first non-sequential location of a vector register file for processing by a first vector processing unit coupled with the memory controller; and the memory controller is further configured to place the second portion in the second non-sequential location of the vector register file for processing by a second vector processing unit coupled with the memory controller.

Example 11 may include the method of example 9, further comprising selecting, by the memory controller, the first non-sequential location of the vector register file from a plurality of locations of the vector register file based at least in part on a starting column address in the instruction.

Example 12 may include the method of example 9, further comprising selecting, by the memory controller, the first non-sequential location of the vector register file a plurality of locations of the vector register file based on whether the retrieving is according to a sequential burst type or an interleaved burst type.

Example 13 may include the method of any of examples 9-12, wherein the sequential data is stored in a dynamic random access memory (DRAM).

Example 14 may include the method of any of examples 9-12, wherein the first portion of the sequential data is 8 bytes of data.

Example 15 may include the method of example 14, wherein the sequential data is 64 bytes of data.

Example 16 may include an apparatus comprising: a dynamic random access memory (DRAM) coupled with a memory controller and configured to store a sequential data; a central processing unit (CPU) coupled with a memory controller, wherein the CPU is configured to transmit an instruction to a memory controller, and wherein the memory controller is configured to: retrieve, by the memory controller and based at least in part on the instruction received from the CPU, a first portion of the sequential data and a second portion of the sequential data, the first portion and the second portion being next to one another in the sequential data; and place the first portion in a first non-sequential location of a vector register file; and place the second portion in a second non-sequential location of the vector register file.

Example 17 may include the apparatus of example 16, further comprising a first processor and a second processor coupled with the memory controller; wherein the first processor is configured to process the first portion in the first non-sequential location; and wherein the second processor is configured to process, concurrently with the first processor, the second portion in the second non-sequential location.

Example 18 may include the apparatus of example 16, wherein the first non-sequential location of the vector register file is selected from a plurality of locations of the vector register file based at least in part on a starting column address in the instruction.

Example 19 may include the apparatus of example 16, wherein the first non-sequential location of the vector register file is selected by the memory controller from a plurality of locations of the vector register file based at least in part on whether the instruction is to retrieve the first portion and the second portion according to a sequential burst type or an interleaved burst type.

Example 20 may include the apparatus of example 16, wherein the first non-sequential location of the vector register file is selected from a plurality of locations of the vector register file based at least in part on a pin setting of the CPU.

Example 21 may include the apparatus of any of examples 16-20, wherein the instruction is first portion of the sequential data is 8 bytes of data.

Example 22 may include the apparatus of example 21, wherein the sequential data is 64 bytes of data.

Example 23 may include one or more computer readable media comprising instructions configured to, upon execution of the instructions by a memory controller, cause the memory controller to: retrieve, based at least in part on an instruction received from a central processing unit (CPU), a first portion of a sequential data and a second portion of the sequential data, the first portion and the second portion being next to one another in the sequential data; place the first portion in a first non-sequential location of a vector register file; and place the second portion in a second non-sequential location of the vector register file.

Example 24 may include the one or more computer readable media of example 23, wherein the instructions are further configured to cause the memory controller to: place the first portion in the first non-sequential location of a vector register file for processing by a first vector processing unit coupled with the memory controller; and place the second portion in the second non-sequential location of the vector register file for processing by a second vector processing unit coupled with the memory controller.

Example 25 may include the one or more computer readable media of example 23, wherein the instructions are further configured to cause the memory controller to select the first non-sequential location of the vector register file from a plurality of locations of the vector register file based at least in part on a starting column address in the instruction.

Example 26 may include the one or more computer readable media of example 23, wherein the instructions are further configured to cause the memory controller to select the first non-sequential location of the vector register file a plurality of locations of the vector register file based on whether the retrieving is according to a sequential burst type or an interleaved burst type.

Example 27 may include the one or more computer readable media of any of examples 23-26, wherein the sequential data is stored in a dynamic random access memory (DRAM).

Example 28 may include the one or more computer readable media of any of examples 23-26, wherein the first portion of the sequential data is 8 bytes of data.

Example 29 may include the one or more computer readable media of example 28, wherein the sequential data is 64 bytes of data.

Example 30 may include an apparatus comprising: means to retrieve, based at least in part on an instruction received from a central processing unit (CPU), a first portion of a sequential data and a second portion of the sequential data, the first portion and the second portion being next to one another in the sequential data; means to place the first portion in a first non-sequential location of a vector register file; and means to place the second portion in a second non-sequential location of the vector register file.

Example 31 may include the apparatus of example 30, further comprising: means to place the first portion in the first non-sequential location of a vector register file for processing by a first vector processing unit; and means to place the second portion in the second non-sequential location of the vector register file for processing by a second vector processing unit.

Example 32 may include the apparatus of example 30, further comprising means to select the first non-sequential location of the vector register file from a plurality of locations of the vector register file based at least in part on a starting column address in the instruction.

Example 33 may include the apparatus of example 30, further comprising means to select the first non-sequential location of the vector register file a plurality of locations of the vector register file based on whether the retrieving is according to a sequential burst type or an interleaved burst type.

Example 34 may include the apparatus of any of examples 30-33, wherein the sequential data is stored in a dynamic random access memory (DRAM).

Example 35 may include the apparatus of any of examples 30-33, wherein the first portion of the sequential data is 8 bytes of data.

Example 36 may include the apparatus of example 35, wherein the sequential data is 64 bytes of data.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

1. A memory controller comprising:
retrieval circuitry configured to retrieve data including a plurality of portions ordered in a first sequence based at least in part on an instruction from a central processing unit (CPU);
reordering circuitry coupled with the retrieval circuitry and configured to reorder the data, based at least in part on the received instruction, so that the plurality of portions are ordered in a second sequence different from the first sequence; and
storage circuitry configured to store, based at least in part on the received instruction, the plurality of portions in a respective plurality of locations of a vector register file in the second sequence.

2. The memory controller of claim 1, wherein the second sequence is based at least in part on a starting column address of the instruction.

3. The memory controller of claim 1, wherein the second sequence is based at least in part on an indication of a burst type in the instruction.

4. The memory controller of claim 3, wherein the indication of the burst type is an indication of whether the burst type is a sequential burst type or an interleaved burst type.

5. The memory controller of claim 1, wherein the second sequence is based at least in part on a pin setting of the CPU.

6. The memory controller of claim 1, wherein the memory controller is coupled with a dynamic random access memory (DRAM) configured to store the data.

7. The memory controller of claim 1, wherein the data is 64 bytes long.

8. The memory controller of claim 7, wherein each portion in the plurality of portions is 8 bytes long.

9. A method comprising:
retrieving, by a memory controller and based at least in part on an instruction received from a central processing unit (CPU), a first portion of a sequential data and a second portion of the sequential data, the first portion and the second portion being next to one another in the sequential data;
placing, by the memory controller, the first portion in a first non-sequential location of a vector register file; and
placing, by the memory controller, the second portion in a second non-sequential location of the vector register file.

10. The method of claim 9, wherein the memory controller is further configured to place the first portion in the first non-sequential location of a vector register file for processing by a first vector processing unit coupled with the memory controller; and
the memory controller is further configured to place the second portion in the second non-sequential location of the vector register file for processing by a second vector processing unit coupled with the memory controller.

11. The method of claim 9, further comprising selecting, by the memory controller, the first non-sequential location of the vector register file from a plurality of locations of the vector register file based at least in part on a starting column address in the instruction.

12. The method of claim 9, further comprising selecting, by the memory controller, the first non-sequential location of the vector register file a plurality of locations of the vector register file based on whether the retrieving is according to a sequential burst type or an interleaved burst type.

13. The method of claim 9, wherein the sequential data is stored in a dynamic random access memory (DRAM).

14. The method of claim 9, wherein the first portion of the sequential data is 8 bytes of data.

15. The method of claim 14, wherein the sequential data is 64 bytes of data.

16. An apparatus comprising:
a dynamic random access memory (DRAM) coupled with a memory controller and configured to store a sequential data;
a central processing unit (CPU) coupled with a memory controller, wherein the CPU is configured to transmit an instruction to a memory controller, and wherein the memory controller is configured to:
retrieve, by the memory controller and based at least in part on the instruction received from the CPU, a first portion of the sequential data and a second portion of the sequential data, the first portion and the second portion being next to one another in the sequential data; and
place the first portion in a first non-sequential location of a vector register file; and
place the second portion in a second non-sequential location of the vector register file.

17. The apparatus of claim 16, further comprising a first processor and a second processor coupled with the memory controller;
wherein the first processor is configured to process the first portion in the first non-sequential location; and
wherein the second processor is configured to process, concurrently with the first processor, the second portion in the second non-sequential location.

18. The apparatus of claim 16, wherein the first non-sequential location of the vector register file is selected from a plurality of locations of the vector register file based at least in part on a starting column address in the instruction.

19. The apparatus of claim 16, wherein the first non-sequential location of the vector register file is selected by the memory controller from a plurality of locations of the vector register file based at least in part on whether the instruction is to retrieve the first portion and the second portion according to a sequential burst type or an interleaved burst type.

20. The apparatus of claim 16, wherein the first non-sequential location of the vector register file is selected from a plurality of locations of the vector register file based at least in part on a pin setting of the CPU.

21. The apparatus of claim 16, wherein the instruction is first portion of the sequential data is 8 bytes of data.

22. The apparatus of claim 21, wherein the sequential data is 64 bytes of data.
